(19) United States
(12) Patent Application Publication
(10) Pub. No.: US 2023/0264647 A1
(43) Pub. Date: Aug. 24, 2023

(54) AIRBAG BASE FABRIC, AND METHOD FOR MANUFACTURING AIRBAG BASE FABRIC

(71) Applicant: TOYOBO CO., LTD., Osaka-shi, Osaka (JP)

(72) Inventors: Hiroya TAKEUCHI, Otsu-shi, Shiga (JP); Masashi OONUMA, Osaka-shi, Osaka (JP); Masataka ADACHI, Otsu-shi, Shiga (JP)

(21) Appl. No.: 18/019,321

(22) PCT Filed: Aug. 3, 2021
(86) PCT No.: PCT/JP2021/028812

§ 371 Date: Feb. 2, 2023

(30) Foreign Application Priority Data
Aug. 4, 2020 (JP) 2020-132612
Dec. 23, 2020 (JP) 2020-213852

(51) Int. Cl. B60R 21/235; D03D 1/02

(52) U.S. Cl. CPC B60R 21/235; D03D 1/02; B60R 2021/23509; D10B 2505/124

(57) ABSTRACT

Object:

Conventional woven fabrics mounted on a loom have a fabric length difference between the center portion and the sides of the woven fabric, which increases the flaring rate. In the scouring shrinkage step, yarns shrink and the crimp ratio is changed, which further increases flaring.

Means for achieving object:

The use of a bar temple with a ring function in the weaving process reduces protrusions. Further, by setting the boiling-water shrinkage rate of incorporated additional yarn lower than that of base yarn, the shrinkage of the sides of the fabric can be efficiently suppressed.

### TECHNICAL FIELD

The present invention relates to a fabric for airbags and a method for producing a fabric for airbags.

### BACKGROUND ART

Airbags are mounted on vehicles for the purpose of protecting occupants' bodies by instant inflation with high-temperature and high-pressure gas in a collision accident of a vehicle. High strength and low air permeability are required for the fabric for airbags to withstand the instant inflation caused by the high-temperature, high-pressure gas in the event of an accidental crash.

In order to weave a fabric for airbags having high-strength and low permeability, high-strength yarns are used to weave a fabric with high density. In many cases, in order to further increase the density after weaving, the finished gray fabric is subjected to scouring shrinkage, thus producing a high-quality fabric. In the present invention, the fabric after scouring and shrinkage is referred to as a “fabric for airbags.”

In conventional fabrics for airbags, which are high-density weave fabrics, the left and right sides are each cut with a cutter; however, the cut weft yarn has low tension, and thus, the weft yarn at both sides of the weave fabric shrinks, thus raising the crimp ratio. This would conversely result in a smaller warp crimp ratio at the sides of the weave fabric, and so the warp yarn at selvages has low tension. In this case, tension difference occurs between the center portion and the sides of the weave fabric, which causes a fabric length difference, generating flaring (also called a “wavy selvage” and “loose selvage”). Flaring is a cause of defects at the sides of a weave fabric and a cause of other defects such as high selvages and wrinkles when a weave fabric is rolled into a roll.

A plurality of airbag fabrics as described above are generally stacked and cut into parts by using a laser cutting machine or the like. Airbag fabrics having large flaring at both sides have a different degree of flaring depending on the fabric; accordingly, when multiple sheets are stacked, the overlapping of the fabrics near both sides is poor. In other words, since the fabrics are randomly inflated in three dimensions, the form of the part is not stable during laser cutting, which is likely to cause defects, and cutting can be made up to a few centimeters inside from each side where the inflation of the fabric is small, which increases loss at the sides. Further, the height of the input port of the cutting machine is limited. After stacking, the sides of the fabric become too bulky to fit into the input port of the cutting machine, which results in a reduction in the number of sheets that can be cut at one time, thus causing the problem of decreasing work efficiency.

At the stage of producing a woven fabric, which is the original fabric for airbags, a loom temple device is attached near the cloth fell of the woven fabric in a loom in order to prevent weave shrinkage of the woven fabric during weaving. There are several types of temples, such as bar temples, which hold in the full width direction, and ring temples, which hold the sides of a woven fabric to prevent weave shrinkage in the weft direction of the woven fabric.

The bar temple can hold the entire fabric; however, the holding force at both sides is not sufficiently ensured as compared to that at the center portion; accordingly, an overly high density during weaving generates protrusions at the cloth fell, and the density difference between the center portion and sides of the woven fabric increases, which is likely to generate flaring. An overly high density during weaving in a ring temple eliminates the holding force at the center portion; accordingly, the sides of the woven fabric are pulled to the center portion, and the woven fabric is removed from the ring temple. A high-density woven fabric for airbags that even has uniform density at the sides of the fabric and reduced flaring was difficult to produce.

Further, it has been reported that flaring can be improved by incorporating additional yarn (also referred to as a “tightening yarn” and “selvage-tightening yarn”) having a lower fineness than that of base yarn (warp and weft that form the woven fabric); however, it cannot be said that sufficient effects are attained.

It has been also reported that flaring can be improved by attaching a specialized additional yarn device to the outside of the bar temple and incorporating additional yarn into the device; however, it cannot be said that flaring is sufficiently improved.

### CITATION LIST

### Patent Literature

PTL 1: WO2015/129684
PTL 2: JP2014-181430A

### SUMMARY OF INVENTION

### Technical Problem

An object of the present invention is to reduce occurrence of flaring in a fabric for airbags having unremoved fringe selvages at both sides of a woven fabric.

### Solution to Problem

As a result of an extensive research, the present inventors found that the above object can be achieved by the following means, and accomplished the invention.

Specifically, the present invention is as follows.

(1) A fabric for airbags comprising unremoved fringe selvages at the sides of the fabric, wherein the fabric has a flaring rate of 1.5% or less, and a slope of change in the flaring rate of 0.1 or less.
(2) A fabric for air bags having a difference between warp and weft density of 1.5 yarns/2.54 cm or less.
(3) A fabric for airbags wherein the crimp ratio of the sides of the fabric is 80% or more relative to the crimp ratio of the center of the fabric.
(4) A method for producing a fabric for airbags, comprising performing weaving by using a bar temple device with a ring function,

the bar temple device comprising a ring-shaped weft gripper portion on each side of an inner bar of the bar temple.

(5) A method for producing a fabric for airbags, comprising

performing weaving by incorporating, at each side of the fabric, at least two additional yarns in which the boiling-water shrinkage rate of a base yarn is larger than the boiling-water shrinkage rate of the additional yarn, and the difference in the boiling-water shrinkage rate between the base yarn and the additional yarn is 0.8% or more, using a bar temple device with a ring function, the bar temple device comprising a ring-shaped weft gripper portion on each side of an inner bar of the bar temple, and

then performing scouring shrinkage.

### Advantageous Effects of Invention

Specifically, by weaving a fabric using a temple device with rings attached to both sides of an inner bar of the bar temple (referred to below as the “bar temple with a ring function”), it is possible to increase the holding force of the sides of the fabric while maintaining the weaving width and conventional workability. This allows the tension of warp during weaving on a loom in the width direction to be uniform, and facilitates the balancing of the density of warp and weft of the entire woven fabric. Accordingly, the difference between warp and weft density can be reduced even up to the sides of the woven fabric. Further, the uniform tension of the warp in the width direction reduces the difference in the warp crimp ratio between the center and sides of the fabric, which reduces the fabric elongation difference between the center and sides of the woven fabric, consequently reducing flaring. A high-quality, high-density fabric for airbags with less flaring can thereby be stably produced.

Furthermore, the incorporation of additional yarn having a different boiling-water shrinkage rate from that of base yarn (boiling-water shrinkage rate of base yarn>boiling-water shrinkage rate of additional yarn) suppresses deformation at the sides of the fabric by shrinkage because adjacent additional yarn has a shrinkage lower than that of the base yarn even when the base yarn is about to shrink due to boiling water. This consequently reduces the flaring rate.

In the weaving stage, the use of the bar temple with a ring function reduces the difference in warp and weft density, which significantly contributes to a reduction in the flaring rate. With the combination of the technique using the specific additional yarn, it is possible to produce a fabric for airbags having further enhanced performance in which the structure even up to the sides of the fabric can be highly controlled.

### BRIEF DESCRIPTION OF DRAWINGS

FIG. 1 shows a bar temple with a ring function.

FIG. 2 shows a method for measuring the flaring rate.

### DESCRIPTION OF EMBODIMENTS

The fabric for airbags according to the present invention is a woven fabric formed from a synthetic-fiber multifilament. The synthetic-fiber multifilament that constitutes the fabric for airbags has a total fineness of preferably 200 dtex or more and 600 dtex or less, and more preferably 300 dtex or more and 550 dtex or less. A total fineness of 200 dtex or more, due to the elimination of the need for overly increasing the weaving density, reduces an excessive increase in binding force of the warp and weft, thus making it easier for the packageability in an airbag module to fall within an appropriate range. A total fineness of 600 dtex or less makes it easier to reduce an excessive increase in rigidity of the yarns that constitute the woven fabric. A synthetic-fiber multifilament having a total fineness within the range of 200 dtex or more and 600 dtex or less is preferable because such a synthetic-fiber multifilament makes it easier to obtain a fabric for airbags that is moderately flexible and thus excellent in packageability in a module.

In the present invention, the total fineness of synthetic-fiber multifilament that constitutes the fabric for airbags is determined as follows. The warp yarns and weft yarns of a fabric obtained through a dry-finishing step are each removed from the fabric, and measurement is performed in accordance with JIS L 1013 (2010) 8.3.1. Specifically, a sample with a length of 90 cm is accurately taken with an initial tension applied. The absolute dry mass is measured, and the fineness based on corrected weight (dtex) is calculated using the following formula. The average of five measurements is determined to be the total fineness.

F0=10000×m/0.9×(100+R0)/100

F0: Fineness based on corrected weight (dtex)
m: Absolute dry mass of sample (g)
R0: Official moisture content (%)

The fabric for airbags of the present invention is woven with base yarn (warp and weft that compose the fabric for airbags) and woven by further incorporating additional yarn having specific physical properties.

In order to suppress flaring due to the shrinkage at the sides of the fabric during scouring shrinkage, as well as drying, the difference in the boiling-water shrinkage rate between the base yarn and the additional yarn is preferably 0.8 to 20%, more preferably 1.5 to 15%, and particularly preferably 4 to 12%. A difference in the boiling-water shrinkage rate between the base yarn and the additional yarn of below 0.8% reduces the effect of suppressing deformation due to shrinkage, whereas a difference in the boiling-water shrinkage rate between the base yarn and the additional yarn exceeding 20% adversely affects strength, air permeability, etc. since the base yarn shrinks too much, thereby damaging the weave structure.

The boiling-water shrinkage rate of the base yarn is preferably larger than the boiling-water shrinkage rate of the additional yarn.

The boiling-water shrinkage rate of the base yarn and the additional yarn used in the fabric for airbags in the present invention may be such that base yarn>additional yarn, and it is effective that the difference between them is 0.83 or more. The additional yarn may be multifilament yarn, monofilament yarn, or yarn subjected to crimping such as false twisting. The material used can be nylon 66 fiber, nylon 6 fiber, polyester fiber, etc. Typically, nylon 66 fiber is often used as the base yarn for the fabric for airbags. Since polyester fiber has a boiling-water shrinkage rate lower than that of nylon 66 fiber, it is preferable to use nylon 66 fiber as the base yarn and polyester fiber as the additional yarn.

In the present invention, the boiling-water shrinkage rate of the original yarn is measured in accordance with boiling-water shrinkage rate method B prescribed in JIS L 1013 (2010). Specifically, the boiling-water shrinkage rate is measured as follows. An initial tension is applied to a sample, and two points 500 mm apart are marked. The initial tension is then removed, and the sample is immersed in hot water at 100° C. for 30 minutes. The sample is then taken out, and water is gently wiped away with blotting paper or a cloth. The sample is air-dried, and then initial tension is applied again. The length between the two points is measured, and the dimensional change rate due to boiling water (%) is calculated using the following formula. The average of three measurements is determined to be the boiling-water shrinkage rate. When a sample shrinks as in the present invention, the dimensional change rate due to boiling water (%) is a negative value, and the absolute value (%) is defined as the boiling water shrinkage rate (%) of the present invention.

Boiling-water shrinkage rate (%)=(L−500)/500×100

L: length between two points (mm)

The material of the synthetic-fiber multifilament that constitutes the fabric for airbags according to the present invention is not particularly limited, and can be selected from a wide range of materials. To meet the characteristics described above, while taking economic efficiency into account, the material is preferably a multifilament composed of a polyamide based-resin such as nylon 6, nylon 66, and nylon 46, or a multifilament composed of a polyester-based resin that contains mainly polyethylene terephthalate.

The synthetic-fiber multifilament that constitutes the fabric for airbags according to the present invention may contain various additives that are typically used for improving the productivity or characteristics in the production process for the original yarn or in the production process for the fabric. The synthetic-fiber multifilament that constitutes the fabric for airbags according to the present invention, for example, may contain at least one member selected from the group consisting of heat stabilizers, antioxidants, light stabilizers, lubricants, antistatic agents, plasticizers, thickening agents, pigments, and flame retardants.

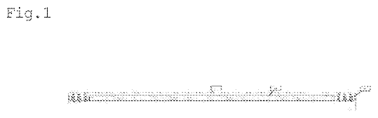

The fabric for airbags of the present invention is weaved by adjusting an appropriate tension and the number of weft yarns to be incorporated, while incorporating a bar temple with a ring function into a loom and considering the weaving properties. As shown in FIG. 1, the bar temple with a ring function has a structure in which a ring function c is provided at both sides of an inner bar b in a bar temple cover a. The surface of the inner bar b is plain or threaded, and the needles in the ring function c are arranged in one or more rows in the width direction. Furthermore, the inner bar b and the ring function c are detachable and are integrated during weaving. The additional yarn is incorporated using a separate winding device or is wound onto a loom beam beforehand for weaving.

The diameter of the inner bar b is preferably 5 mm to 50 mm, and the surface is preferably plain or threaded (screw with a minimum of one thread and a maximum of three). The material can be selected from POM (polyacetal), PET (polyethylene terephthalate), and metals having high corrosion and rust resistance (brass, aluminum, etc.). Furthermore, the bar temple can be plated to reduce damage to the original yarn (for anti-fluffing).

The number of additional yarns of the fabric for airbags according to the present invention is not particularly limited; however, as the number increases, the effect is likely to increase. Considering ease of operation or the like, the number of additional yarns is preferably 2 to 12. However, since the operation properties and quality differ depending of production facility, the number of additional yarns is not limited as long as the operation properties and quality are not impaired.

The width of the fabric for airbags according to the present invention is not particularly limited; however, the greater the width, the more likely that flaring will occur. Fabric for airbags with a width of 160 cm or more is effective, and a width of 180 cm or more is particularly effective.

The flaring reduction technique of the present invention particularly effectively works for a high-density fabric. The fabric for airbags according to the present invention preferably has a cover factor of 1800 to 2600, and particularly preferably 2000 to 2500.

The CF was measured using the following formula:

CF=(A×0.9)^{1/2}×(W1)+(B×0.9)^{1/2}×(W2)

wherein A and B indicate the thickness (dtex) of warp and weft, and W1 and W2 indicate a warp weaving density and a weft weaving density (yarns/2.54 cm).

The structure of the woven fabric of the fabric for airbags according to the present invention can be a plain weave, a twill weave, a sateen weave, or a variation of these weaving patterns; however, the structure is not particularly limited.

By incorporating additional yarn having a difference in the boiling-water shrinkage rate from that of base yarn of 3% or more (base yarn>additional yarn) into the selvages of the fabric for airbags according to the present invention, the flaring rate of the fabric for airbags is reduced to 1.5% or less, and the slope of the change in the flaring rate is reduced to 0.1 or less. Further, the difference in warp and weft density can be reduced to 1.5 yarns/2.54 cm or less.

Furthermore, the fabric for airbags according to the present invention can be further coated, as necessary, with silicone resin or the like, which can improve low air permeability. Such a fabric can be effectively used as a fabric for coated airbags.

### EXAMPLES

The structure and effect of the present invention are explained in detail using Examples.

### Measurement of Flaring Rate

The flaring rate indicates the rate of the length of the sides of the fabric relative to the length of the center portion of the fabric.

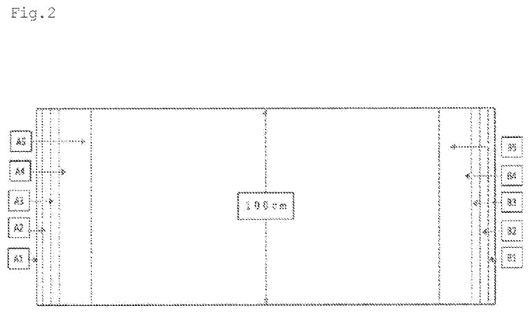

A full-width woven fabric having a length of the center portion of 100 cm is prepared, and the woven fabric is cut along with the weft yarn located at the front and rear sides of the center portion of the woven fabric (100-cm portion) until both sides. Further, as shown in FIG. 2, the following samples are cut from a side.

A1: A sample with a width of 1 cm cut from the position 1 cm from one side.
A2: A sample with a width of 2 cm from the position 2 cm from one side.
A3: A sample with a width of 2 cm from the position 4 cm from one side.
A4: A sample with a width of 6 cm from the position 6 cm from one side.
A5: A sample with a width of 10 am from the position 12 cm from one side.
B1: A sample with a width of 1 cm from the position 1 cm from the other side.
B2: A sample with a width of 2 cm from the position 2 cm from the other side.
B3: A sample with a width of 2 cm from the position 4 cm from the other side.
B4: A sample with a width of 6 cm from the position 6 cm from the other side.
B5: A sample with a width of 10 cm from the position 12 cm from the other side.

After cutting, the length of the center portion of each cut sample is measured, and measurement results are substituted into the following formula. Because flaring of the fabric is present at both sides, F1 or F2, whichever value is higher, is taken as the flaring rate of the fabric for airbags. Similarly, X1 or X2, whichever value is higher, is taken as the slope of the change in the flaring rate.

Flaring rate F1=(A1−100)/100*100

Flaring rate F2=(B1−100)/100*100

F1 or F2, whichever value is higher, is the flaring rate of the fabric for airbags.

Slope of the change in the flaring rate X1=(A1−A5)/15.5

Slope of the change in the flaring rate X2=(B1−B5)/15.5

The distance between measurement positions of A1 and A5 samples is 15.5 cm.

X1 or X2, whichever value is higher, is the slope of the change in the flaring rate of the fabric for airbags.

### Weaving Density of Fabric

The measurement was performed in accordance with JIS L 1096 (2010) 8.6.1. More specifically, a sample was placed on a flat table, and unnatural crimping and tension were removed. The number of warp yarns and weft yarns in a 2.54-cm section was counted and determined to be the density. The number of measurements was at least n=35 at 5-cm intervals from the base of the selvage, and both warp (longitudinal) and weft (latitudinal) densities were measured, and the difference therebetween was calculated at each measurement point.

### Measurement of Crimp Ratio

The crimp ratio was measured in accordance with the method described in JIS L1096 (1999) 8.7.2B.

As a sample, 10 warp yarns were extracted from the center of the fabric and 10 base yarns at the endmost in the warp direction excluding the additional yarn were extracted from each of the left and right sides of the fabric, and the average values for both the center and side of the fabric were determined.

Thereafter, by substituting the crimp ratio of the center of the fabric, and the crimp ratio of the sides having a larger difference from the center of the fabric, the difference in the warp crimp ratio between the center and the sides of the fabric can be confirmed.

Difference in the warp crimp ratio between the center and sides of the fabric=the warp crimp ratio of the sides of the fabric/the warp crimp ratio of the center of the fabric×100

### Example 1

Using a nylon 66 filament original yarn having a fineness of 470 dtex/144 f and a boiling-water shrinkage rate of 5.5% (the monofilament cross-section was round) in the weft and warp direction of the base yarn, weaving was performed in a plain weave pattern so that the weft and warp both had a weaving density of 49.0 yarns/2.54 cm, by incorporating two additional yarns having a boiling-water shrinkage rate of −1.3% with a water-jet loom equipped with a bar temple with a ring function (15-mm diameter, inner bar surface plane). Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Example 2

Using a nylon 66 filament original yarn having a fineness of 470 dtex/144 f and a boiling-water shrinkage rate of 5.5% (the monofilament cross-section was round) in the weft and warp direction of the base yarn, weaving was performed in a plain weave pattern so that the weft and warp both had a weaving density of 49.0 yarns/2.54 cm, by incorporating two additional yarns having a boiling-water shrinkage rate of 4.5% with a water-jet loom equipped with a bar temple with a ring function (15-mm diameter, inner bar surface plane). Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Example 3

Using a nylon 66 filament original yarn having a fineness of 470 dtex/144 f and a boiling-water shrinkage rate of 5.5% (the monofilament cross-section was round) in the weft and warp direction of the base yarn, weaving was performed in a plain weave pattern so that the weft and warp both had a weaving density of 53.0 yarns/2.54 cm, by incorporating two additional yarns having a boiling-water shrinkage rate of −1.3% with a water-jet loom equipped with a bar temple with a ring function (15-mm diameter, inner bar surface plane). Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Example 4

Using a nylon 66 filament original yarn having a fineness of 470 dtex/144 f and a boiling-water shrinkage rate of 5.5% (the monofilament cross-section was round) in the weft and warp direction of the base yarn, weaving was performed in a plain weave pattern so that the weft and warp both had a weaving density of 53.0 yarns/2.54 cm, by incorporating two additional yarns having a boiling-water shrinkage rate of 4.5% with a water-jet loom equipped with a bar temple with a ring function (15-mm diameter, inner bar surface plane). Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Example 5

Using a nylon 66 filament original yarn having a fineness of 470 dtex/144 f and a boiling-water shrinkage rate of 7.0% (the monofilament cross-section was round) in the weft and warp direction of the base yarn, weaving was performed in a plain weave pattern so that the weft and warp both had a weaving density of 53.0 yarns/2.54 cm, by incorporating two additional yarns having a boiling-water shrinkage rate of 7.0% with a water-jet loom equipped with a bar temple with a ring function (15-mm diameter, inner bar surface plane). Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Comparative Example 1

Using a nylon 66 filament original yarn having a fineness of 470 dtex/144 f and a boiling-water shrinkage rate of 5.53 (the monofilament cross-section was round) in the weft and warp direction of the base yarn, weaving was performed in a plain weave pattern so that the weft and warp both had a weaving density of 53.0 yarns/2.54 cm, by incorporating two additional yarns having a boiling-water shrinkage rate of 5.0% with a water-jet loom equipped with a bar temple. Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

### Comparative Example 2

Using a nylon 66 filament original yarn having a fineness of 470 dtex/144 f and a boiling-water shrinkage rate of 7.0% (the monofilament cross-section was round) in the weft and warp direction of the base yarn, weaving was performed in a plain weave pattern so that the weft and warp both had a weaving density of 53.0 yarns/2.54 cm, by incorporating two additional yarns having a boiling-water shrinkage rate of 7.0% with a water-jet loom equipped with a bar temple. Thereafter, the fabric was passed through a hot-water shrinkage tank at 98° C. without drying and then continuously passed through a dry-finishing process using a two-step suction drum dryer in which the first step was adjusted to have a temperature T1 of 130° C., and the second step was adjusted to have a temperature T2 of 135° C.

TABLE 1

| | | | | | | | | Comparative | Comparative |
|---|---|---|---|---|---|---|---|---|---|
| Item | Unit | | Example 1 | Example 2 | Example 3 | Example 4 | Example 5 | Example 1 | Example 2 |
| Total fitness of original | dtex | | 470 | 470 | 470 | 470 | 470 | 470 | 470 |
| yarn | | | | | | | | | |
| Number of original yarns | yarns | | 144 | 144 | 144 | 144 | 144 | 144 | 144 |
| Loom | — | | WJL | WJL | WJL | WJL | WJL | WJL | WJL |
| Holding device | | | Bar temple | Bar temple | Bar temple | Bar temple | Bar temple | Bar temple | Bar temple |
| | | | with a ring | with a ring | with a ring | with a ring | with a ring | | |
| | | | function | function | function | function | function | | |
| | Ring needle | | Two rows | Two rows | Two rows | Two rows | Two rows | — | — |
| | Inner bar diameter | | 15-mm dia. | 15-mm dia. | 15-mm dia. | 15-mm dia. | 15-mm dia. | 9-mm dia. | 9-mm dia. |
| | Material | | POM | POM | POM | POM | POM | POM | POM |
| | Surface | | Plane | Plane | Plane | Plane | Plane | Double- | Double- |
| | | | | | | | | thread | thread |
| | | | | | | | | screw | screw |
| Number of additional yarns | Yarns | | 2 | 2 | 2 | 2 | 2 | 2 | 2 |
| (each side) | | | | | | | | | |
| Shrinkage rate of base yarn | % | | 5.5 | 5.5 | 5.5 | 5.5 | 7.0 | 5.5 | 7.0 |
| Boiling-water shrinkage | % | | −1.3 | 4.5 | −1.3 | 4.5 | 7.0 | 5.0 | 7.0 |
| rate of additional yarn | | | | | | | | | |
| Difference in boiling-water | % | | 6.8 | 1.0 | 6.8 | 1.0 | 0.0 | 0.5 | 0.0 |
| shrinkage rate | | | | | | | | | |
| Weave design density | Yarns/ | Warp | 49.0 | 49.0 | 53.0 | 53.0 | 53.0 | 53.0 | 53.0 |
| | 2.54 cm | Weft | 49.0 | 49.0 | 53.0 | 53.0 | 53.0 | 53.0 | 53.0 |
| Actual density at the side | Yarns/ | Warp | 50.1 | 50.3 | 54.1 | 54.2 | 54.4 | 54.9 | 54.7 |
| | 2.54 cm | Weft | 49.2 | 49.1 | 53.4 | 53.1 | 53.2 | 53.2 | 53.1 |

| | | | | | | | | |
|---|---|---|---|---|---|---|---|---|
| Flaring rate | % | 0.80 | 0.98 | 0.97 | 1.01 | 1.15 | 1.70 | 1.72 |
| Slope of change in flaring | — | 0.04 | 0.07 | 0.05 | 0.08 | 0.09 | 0.12 | 0.13 |
| rate | | | | | | | | |
| Difference in density | Yarns/2.54 cm | 0.9 | 1.2 | 0.7 | 1.1 | 1.2 | 1.7 | 1.6 |
| between warp and weft | | | | | | | | |
| Warp crimp ratio | Center of fabric | 9.9 | 9.7 | 13.4 | 11.8 | 11.4 | 11.0 | 11.1 |
| | Side of fabric | 8.1 | 7.9 | 11.9 | 10.1 | 9.5 | 8.1 | 8.5 |
| Warp crimp ratio of the | % | 81.8 | 81.4 | 88.3 | 85.6 | 83.3 | 73.6 | 76.6 |
| sides of fabric/warp crimp | | | | | | | | |
| ratio of the center of | | | | | | | | |
| fabric × 100 | | | | | | | | |

### INDUSTRIAL APPLICABLE

According to the present invention, specifying the flaring rate can improve the quality of the fabric for airbags and contribute to reduction in costs in the airbag manufacturing industry.

1. A fabric for airbags comprising unremoved fringe selvages at the sides of the fabric, wherein the fabric has a flaring rate of 1.5% or less, and a slope of change in the flaring rate of 0.1 or less.

2. The fabric for air bags according to claim 1, wherein the fabric has a difference between warp and weft density of 1.5 yarns/2.54 cm or less.

3. The fabric for airbags according to claim 1, wherein the warp crimp ratio of the sides of the fabric is 80% or more relative to the warp crimp ratio of the center portion of the fabric.

4. A method for producing the fabric for airbags according to claim 1, comprising performing weaving by using a bar temple device with a ring function, the bar temple device comprising a ring-shaped weft gripper portion on each side of an inner bar of the bar temple.

5. A method for producing the fabric for airbags according to claim 1, comprising:
performing weaving by incorporating, at each side of the fabric, at least two additional yarns in which the boiling-water shrinkage rate of a base yarn is larger than the boiling-water shrinkage rate of the additional yarn, and the difference in the boiling-water shrinkage rate between the base yarn and the additional yarn is 0.8% or more, using a bar temple device with a ring function, the bar temple device comprising a ring-shaped weft gripper portion on each side of an inner bar of the bar temple, and
then performing scouring shrinkage.
